(19) United States
(12) Patent Application Publication
(10) Pub. No.: US 2005/0083984 A1
(43) Pub. Date: Apr. 21, 2005

(54) Laser system sealing

(76) Inventors: Igor Bragin, Goettingen (DE); Rainer Paetzel, Dransfeld (DE); Juergen Baumler, Osterode (DE); Heiko Diesing, Adelebsen (DE); Helmer Beulshausen, Einbeck (DE); Ulrich Rebhan, Goettingen (DE)

Correspondence Address: STALLMAN & POLLOCK LLP, SUITE 2200, 353 SACRAMENTO STREET, SAN FRANCISCO, CA, 94111, US

(21) Appl. No.: 10/963,284

(22) Filed: Oct. 12, 2004

Related U.S. Application Data
(60) Provisional application No. 60/512,165, filed on Oct. 17, 2003.

(51) Int. Cl. H01S 3/22

(52) U.S. Cl. 372/58; 372/57; 372/59

(57) ABSTRACT

The lifetime of the laser gas in a laser system such as an excimer laser can be increased by changing the way in which the laser system is sealed. In addition to primary seals used to seal the reservoir chamber and discharge channel, at least one secondary seal can be used between the primary seals and the surrounding environment in order to further prevent permeation of impurities into the discharge chamber, as well as to create an intermediate gas volume. A controlled atmosphere can be generated in the intermediate gas volume, which can be at a slightly higher pressure than the surrounding environment in order to resist the flow of impurities through the secondary seal(s). Further, a flow of purge gas can be introduced into the controlled atmosphere in order to carry away any impurities that leak through the secondary seal(s).

### CLAIM OF PRIORITY

The present application claims priority to U.S. Provisional Patent Application No. 60/512,165, entitled “RESERVOIR CHAMBER SEALING,” filed Oct. 17, 2003, which is hereby incorporated herein by reference.

### TECHNICAL FIELD OF THE INVENTION

The present invention relates to an excimer or molecular fluorine laser system, especially a laser system with different seals.

### BACKGROUND

Semiconductor manufacturers are currently using deep ultraviolet (DUV) lithography tools based on KrF-excimer laser systems, operating at wavelengths around 248 nm, as well as ArF-excimer laser systems, which operate at around 193 nm. Vacuum UV (VUV) tools are based on F₂-laser systems operating at around 157 nm. These relatively short wavelengths are advantageous for photolithography applications because the critical dimension, which represents the smallest resolvable feature size that can be produced photolithographically, is proportional to the wavelength used to produce that feature. The use of smaller wavelengths can provide for the manufacture of smaller and faster microprocessors, as well as larger capacity DRAMs, in a smaller package. In addition to having smaller wavelengths, such lasers have a relatively high photon energy (i.e., 7.9 eV) which is readily absorbed by high band gap materials such as quartz, synthetic quartz (SiO₂), Teflon (PTFE), and silicone, among others. This absorption leads to excimer and molecular fluorine lasers having even greater potential in a wide variety of materials processing applications. Excimer and molecular fluorine lasers having higher energy, stability, and efficiency are being developed as lithographic exposure tools for producing very small structures as chip manufacturing proceeds into the 0.18 micron regime and beyond. The desire for such submicron features comes with a price, however, as there is a need for improved processing equipment capable of consistently and reliably generating such features. Further, as excimer laser systems are the next generation to be used for micro-lithography applications, the demand of semiconductor manufacturers for powers of 40 W or more to support throughput requirements leads to further complexity and expense.

One problem facing laser manufacturers and operators utilizing these excimer lasers for applications such as microlithography involves the leaking and/or diffusion of impurities, such as water vapor and ambient air (oxygen, etc.), into the reservoir chamber. Another problem involves the introduction of contamination or impurities due to outgassing of the laser system. These impurities cannot only degrade the quality of the laser output, but can shorten the lifetime of the laser gas. This decrease in gas lifetime leads to an increase in both the overall cost of system operation and the amount of system downtime.

### BRIEF DESCRIPTION OF THE DRAWINGS

FIG. 1 is a diagram showing a cross-section of a double o-ring configuration that can be used in accordance with one embodiment of the present invention.

FIG. 2 is a diagram showing a cross-section of a laser device having first and second seals in accordance with one embodiment of the present invention.

FIG. 3 is a diagram showing an exploded perspective view of a laser device having first and second seals in accordance with another embodiment of the present invention.

FIG. 4 is a diagram of an overall laser system that can be used in accordance with the embodiments of FIGS. 1-3.

### DETAILED DESCRIPTION

Systems and methods in accordance with various embodiments of the present invention can overcome these and other deficiencies in existing laser systems by changing the way in which components of the laser system are sealed. In particular, a laser system in accordance with one embodiment utilizes a double seal approach, wherein a purge gas is utilized between the two seals to create an intermediate sealed atmosphere, substantially impeding impurities from flowing and/or diffusing into the reservoir chamber.

There have been many approaches to improving the technology utilized to seal a reservoir chamber. The performance of these sealing approaches can be measured using four parameters: the permeation, the outgassing, the photo-chemically induced outgassing, and the leak tightness of the seal. These parameters can directly affect the performance of the laser system. For example, improving the permeation performance and/or the outgassing performance of the seal can have a positive impact on the lifetime of the laser gas and window(s), while having a substantial positive impact on the shelf lifetime, passivation status/re-passivation effort, and the static gas lifetime. Improving the photo-chemically induced outgassing performance can have positive effects on the reservoir chamber lifetime, window lifetime, dynamic gas lifetime, and static gas lifetime. Improving the leak tightness can have a significant positive effect on the lifetime of the laser gas and window(s), while having a substantial positive effect on the passivation status/re-passivation effort and the static gas lifetime. Adjusting the parameters also can take into account the importance of each specification, as the specifications in descending order of importance for one embodiment include the reservoir chamber lifetime, shelf lifetime, window lifetime, passivation status/re-passivation effort, dynamic gas lifetime, and static gas lifetime. It should be understood that these parameters and specifications are exemplary, and are not meant to be an exhaustive listing of parameters and specifications that can be adjusted and/or improved in order to improve the performance of a laser system. Further, there may be other orders of importance or balancing of parameters depending upon the system and/or application. The parameters and specifications above are selected to correspond to an ideal seal for a laser system in accordance with one embodiment, which can be used with a variety of applications.

In existing systems where a ceramic discharge channel is in thermal contact with a metal reservoir chamber and metal cathode plate, a number of different elastomer seals have been used in an attempt to prevent impurities outside the system from passing into the reservoir chamber. In many systems a fluoro-elastomer, such as Viton® from DuPont Dow Elastomers of Wilmington, Del., or any other material in the FKM fluoro-elastomer category according to the American standard ASTM, can be used in o-ring form for the majority of the seals in a laser system. The permeation of air and water through such an o-ring is relatively high, however, and outgassing and photochemical outgassing can be a problem due to the presence of a filler material such as carbon. Other fluoro-elastomers are available without filler, such as Optic Armor fluoro-elastomers from of Nippon Valqua Industries of Tokyo, Japan. In these types of seals the outgassing and photochemical outgassing is greatly reduced due to the absence of the filler material, but due to the absence of the inorganic filler material the permeation can be quite large.

Another type of o-ring that can be used is a perfluoro-elastomer seal, which can be made of a perfluoro-elastomer such as Kalrez® from DuPont Dow Elastomers of Wilmington, Del., or any other material in the FFKM fluoro-elastomer category according to the American standard ASTM. This type of o-ring can be used where the system has stringent chemical requirements, as these rings provide reduced outgassing, but the permeation performance can be significantly worse than for fluoro-elastomers. Further, perfluoro-elastomers can be quite expensive, such that there is little motivation to use these seals.

Different sealing technologies can be compared by examining and comparing, for example, the permeation, outgassing, photochemistry, cost, and overall process performance using these seals. For example, a double o-ring configuration using a fluoro-elastomer such as Viton performs comparably to a weld or solder joint when using these criteria. A single ring configuration of a fluoro-elastomer such as Optic Armor performs slightly less comparably, due in part to the permeation characteristics. Other approaches such as single o-ring seals using fluoro-elastomers such as Viton or perfluoro-elastomers such as Kalrez, or using metal sealing, perform even worse by comparison, due to for exampe the outgassing of the o-rings and the cost of the metal seal. It should be mentioned that o-rings also can perform differently for different impurities. For example, a fluoro-elastomer such as Viton has permeation values (in 10E-8 cm³ cm/sec cm² atm) of 16 for He, 1.1 for O₂, 40 for H₂O, and 0.33 for N₂, while a perfluoro-elastomer such as Kalrez has permeation values of 190 for He, 6 for O₂, 100 for H₂O, and 3.8 for N₂.

Another previous approach involved using a metal seal in place of at least some of the elastomeric seals. From a technical standpoint a metal seal can be preferable for various embodiments where use of a seal cannot be avoided through design. The permeation and outgassing of metal seals meet current UHV standards, and can be well-suited for applications such as lithography. A clear disadvantage to using metal seals, however, is the resultant cost. The cost is not only recognized in the price of the metal seal itself, but in the changes in the design and/or process necessary to compensate for the presence of the metal seal. For example, the thermal expansion coefficient of the metal seal is different from that of the ceramic channel, which in turn is different from the expansion coefficient of the aluminium reservoir chamber. These differing expansion coefficients can affect the performance of the seal under different temperatures. While it would be possible to use a stainless steel tube or other design alternative, these alternatives can be significantly more expensive to design and implement. It can be desirable to develop an approach that retain as much as possible from the ceramic frame structure while adapting the structure to metal sealing.

A number of approaches have been attempted to adapt a laser chamber for a metal seal, including using a metal wire as a seal or using a professional δ-type (“delta-type”) seal, such as a delta-type Helicoflex seal from Garlock Helicoflex of Columbia, S.C., which is an elastic metal seal having benefits similar to those of an elastomer and/or traditional metal seal. The primary difficulties in using such a metal sealing with a ceramic frame structure is that a long straight seal is required that has relatively sharp corners, which can be somewhat difficult to machine. Since the temperature coefficients of these seals are different from that of the ceramic channel positioned between the seals, a material such as stainless steel can be preferable but would come with a significant increase in cost.

One alternative is to use an indium wire for the metal seal. Indium has the advantage of being relatively soft, which allows for the creation of a seal with reasonable pressure. For instance, a torque of 750 Nm can be applied to the bolts of the cathode plate of a laser system. This can be a significant advantage, particularly when used to seal the large ceramic frame. Seals with Indium wire can be used to seal the contact area between the reservoir chamber and the ceramic frame, as well as between the ceramic frame and the cathode plate. Indium wire can be used relatively safely to make initial seal, but requires a high skill set and is not ideal for mass production. Leaks have been found to occur with Indium seals after about three months, as Indium is not corrosion resistant in presence of fluorine and air. The presence of these small leaks leads to a corrosion of the Indium, whereby the leak(s) rapidly grows to become severe. Indium wire seals can only be reworked with major effort, and it can be difficult to extract an indium seal as the wire typically decomposes and sticks to the surface being sealed. Indium also has pronounced cold-flow characteristics, whereby the pressure on the seal virtually disappears. Any thermally-induced movement of the channel versus tube and/or cathode plate can lead to certain material flow of the seal.

Metal wire alternatives to Indium have been examined to attempt to overcome some of these deficiencies. Experiments with tin (SN) seals were not favorable, as the initial seal was reached but leakage occurred after cycling of the warm/cold periods of the laser system. Other experiments using metal wire with ceramic frames have not proven to be effective and cost-efficient.

Another approach that has been examined involves c-type metal seals, or metal c-rings, such as are available from Garlock France of St. Etienne, France or GFD Technology GmbH of Hückelhofen-Baal, Germany. C-type seals can be appealing, as c-type seals are easier to make in the necessary circular shape. Other shapes can be difficult, however, as sharp corners are difficult with metal c-type seals and long straight seals tend to twist. It also has proven top be somewhat difficult to obtain good quality seals. When used with ceramic structures in existing laser designs, the length of the seal and the groove fitting have proven to be problematic. One design using such c-seals involves using a-optimized (where a is the thermal expansion coefficient) stainless steel for the cathode plate, the reservoir chamber, and the side flanges. The choice of stainless steel instead of the standard aluminium can be necessary to match the thermal expansion coefficient of the metal with the ceramic frame, particularly when metal seals are used between the cathode plate and the ceramic channel, as well as between the ceramic channel and the reservoir chamber. In addition to the added cost, however, stainless steel brings other advantages/disadvantages relative to the standard aluminum. For example, stainless steel has a more favorable temperature coefficient, and is more compatible with welding. The ability to weld can eliminate the need for seals in some places, such as in the side flanges. Stainless steel is much heavier, however, is harder to manufacture, and is significantly more expensive when used for the reservoir chamber.

Another previous approach to extending the laser gas lifetime involved coating some of the laser parts with nickel in order to produce a surface that is inert to the laser gas. Experiments with lasers such as K200X lasers and A4003 lasers available from Lambda Physik AG of Göttingen, Germany, however, showed no significant advantage to nickel coating a reservoir chamber shows over the performance of an ordinary aluminium tube. The advantages of such a surface finish might be more substantial once the improvements in sealing technology are implemented in such lasers and the testing is repeated. Potential advantages of the nickel did not show at this point, but may have been hidden by the overwhelming permeation and outgassing of the existing seals.

Other coating approaches have been studied, such as comparing the performance of ordinary stainless steel, electro-polished stainless steel, and nickel coated stainless steel. The nickel coating process of stainless steel parts presents a technology problem which is still unsolved. Presently, a chemical nickel plating is applied which leaves some remaining phosphor. Further, a current two-step process that uses strike nickel and a final coating has been shown to cause undesired leakage.

Stainless steel surfaces have been tested in laser operation, such as where a reservoir chamber was assembled with metal seals using the plain stainless steel surface. The performance of that tube was comparable to what has been measured with an aluminium tube. Problems exist, however, as the static gas lifetime appears to be worse than for the aluminium tube.

An alternative approach to using a metal seal involves using an additional seal, secondary seal, or double seal capable or further preventing contamination. Significant difficulties in the development of a metal sealed laser discharge unit are related to the main seal of the cathode plate to the ceramic channel and the ceramic channel to the reservoir chamber. A double seal allows for addressing the permeation through the o-ring used at these locations. The permeation rate can be determined by the material of the o-ring, the area, the thickness, and the pressure gradient. The intermediate gas volume (IGV) can be at vacuum or a reduced pressure, for example, or can be purged with an inert gas such as argon. The resulting pressure gradient for relevant impurities such as H₂O, O₂, CO₂, and air then approaches zero. As a result, there is no significant amount of permeation and the remaining leaks become much less relevant. The principal of the double seal is well accepted in the design of vacuum equipment as an alternative for metal sealing. There are disadvantages to the use of a double seal instead of metal sealing, however, as outgassing and photochemical induced outgassing still occurs.

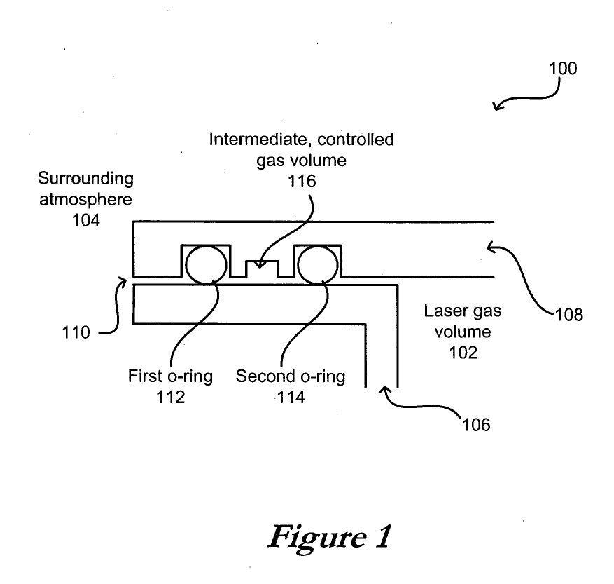

Systems and methods in accordance with various embodiments of the present invention have arrived at a balanced solution that provides acceptable performance at a reasonable cost. For example, in a 193 nm laser system used for lithography where a seal could otherwise allow impurities from the surrounding environment to leak into the laser gas volume, a double o-ring structure can be used that has a volume of controlled gas atmosphere therebetween. Such an arrangement is shown, for example, in FIG. 1. In this exemplary arrangement 100, a cross-section of a portion of a laser system is shown, wherein a volume of laser gas 102 is separated from the surrounding environment 104 by two adjacent components of the laser system, such as a metal reservoir chamber portion 106 and a ceramic member portion 108. The channel 110 formed between the components could allow impurities to enter into the gas volume 102. In order to prevent the passing of impurities, a first o-ring 112 (shown in cross-section) can be used to form a seal in the channel, the material of the first o-ring being of a sufficient diameter that when the portions 106, 108 of the laser system are brought together, the material is sufficiently compressed in the channel to form an acceptable seal. Rings in one system vary from 1.5-5.0 mm in diameter and 16-4,115 mm in length. Dimensions and pressures for forming a seal using o-rings are well known in the art and will not be discussed in detail herein. If this o-ring is made of a fluoro-elastomer such as Viton, there can be some permeation of air and water, for example, through the seal and into the laser gas volume 102. The permeation can be addressed by utilizing a second o-ring 114 positioned concentrically to the first o-ring 112 in the channel 110, or at least positioned elsewhere in the channel relative to the first o-ring in order to form a second seal in the channel where the channel may not be a planar channel. The use of at least one first and second seal creates an intermediate gas volume between the laser gas and the surrounding environment.

The use of a second seal in the channel will increase the ability of the system to prevent impurities from entering into the laser gas volume, but will still allow a level of permeation that might not be acceptable for various applications and/or systems. In order to reduce the effects of permeation of the double seal configuration, a controlled gas volume 116 can be created between the first o-ring 112 and the second o-ring 114, either in the channel 110 or in an additional volume open to the channel. In one embodiment, the controlled intermediate gas volume can be at a vacuum or lower pressure relative to the laser gas volume, such that impurities will not tend to flow across the second o-ring and into the laser gas volume. It can be preferable in many systems, however, for intermediate gas volume to be at a slightly higher pressure relative to the surrounding environment 104, such that impurities will not tend to flow across the seal of the first o-ring 112. There can be a flow of gas into the intermediate gas volume in order to maintain the elevated pressure, as some of the gas will leak out of the intermediate volume over time. A pressure valve can be included with the intermediate gas volume to ensure an upper pressure boundary is not crossed, and that the pressure in the intermediate volume stays within a desired range. The intermediate gas volume also can include a pressure sensor, which can send a signal to a processor and/or pressure control device, in order to adjust a pressure in the intermediate volume. The gas contained in the controlled intermediate gas volume can be a gas such as argon or nitrogen, and can be at a pressure of about 1 atm or at about 5-10 mbar above atmospheric pressure, for example.

It can be preferable for many embodiments for the intermediate volume to utilize a flow of purge gas to carry away any impurities that permeate the first seal. The gas can be provided at a slight overpressure, such as at about 5-10 mbar above atmospheric pressure, in order to impede the flow of gas into the intermediate chamber. The purge gas also can have an input and an output relative to the intermediate gas volume, which in one embodiment is substantially concentric with, but positioned between, the first and second o-rings. While potential impurities such as water, O₂, and CO₂ can permeate and/or flow into the controlled intermediate gas atmosphere over time, either through the first o-ring or through other leaks and/or seals in the laser system, these impurities will not detrimentally affect the laser gas as the second seal will significantly prevent the impurities from flowing into the laser gas volume, and the flow of purge gas in the intermediate gas volume can carry away many of the impurities that permeate into the intermediate gas volume.

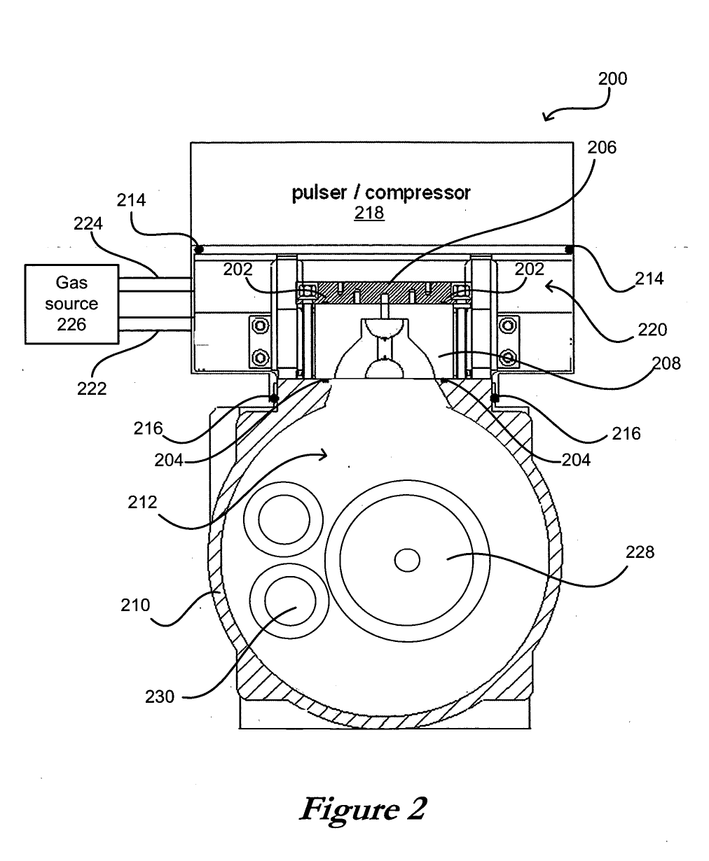

An exemplary arrangement 200 in accordance with one embodiment uses an intermediate controlled gas volume configuration as shown in FIG. 2. In this arrangement, there is a pair of “primary” or “first” o-rings 202, 204 positioned between the cathode plate 206 and ceramic channel member 208, and between the ceramic channel member 208 and the reservoir chamber 210, respectively. The reservoir chamber is shown to have a circulation mechanism 228, here a fan, for circulating the laser gas through the discharge gap between the electrodes in the discharge channel. The gas can pass by a pair of cooling coils 230 before being recirculated by the fan. As can be seen, these o-rings are placed substantially horizontally between these components in order to seal the discharge channel and reservoir chamber of the discharge chamber from the outside atmosphere. These first seals are typically not sufficient, however, as these seals alone over time could allow for the permeation of impurities into the laser gas volume 212. In order to limit the amount of impurities reaching these first seals, a pair of “secondary” or “second” o-rings 214, 216 can be used, between the pulser/compressor module 218 and an EMI-box, and between the EMI-box and the reservoir chamber 210, respectively. Grooves or notches similar to those shown in FIG. 1 can be used to position these secondary o-rings. These secondary seals can be utilized in a substantially horizontal orientation as shown in FIG. 2. An EMI-box as known in the art is typically metal shielding or plating used to shield electromagnetic radiation generated through operation of the laser system. An EMI-box in accordance with embodiments of the present invention can be an air-tight metal box that creates a sealed intermediate atmosphere between the discharge channel and the surrounding atmosphere.

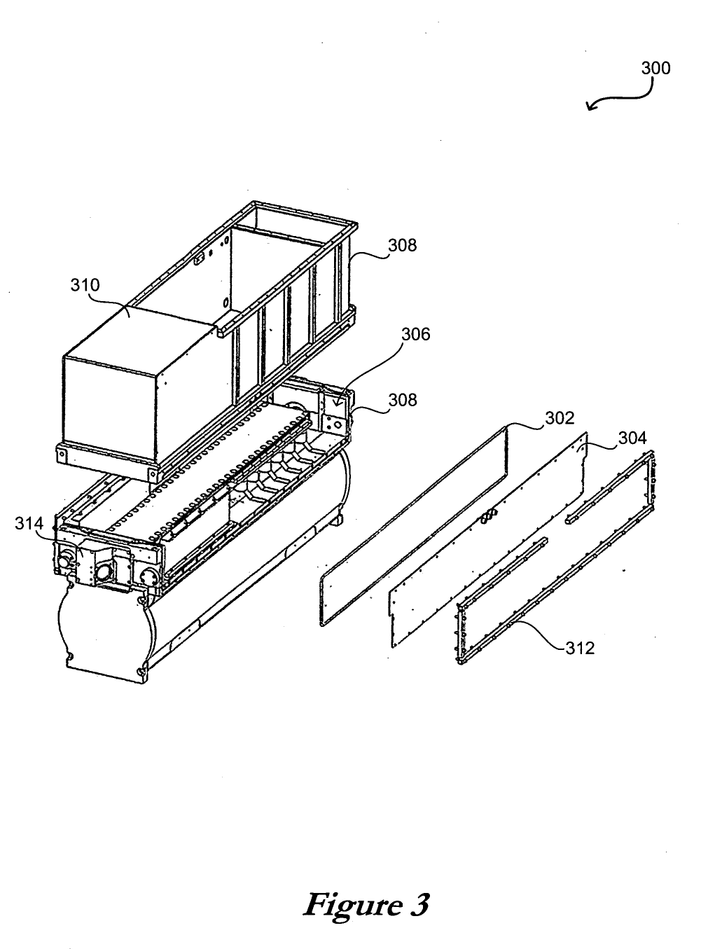

The second o-rings 214, 216 form secondary seals between the first seals and the outer atmosphere, thereby significantly reducing the permeability of the overall laser system. Depending upon the desired performance, the permeation of the gas through the double seal arrangement can be further improved. In this embodiment, the intermediate atmosphere can be obtained by introducing a flow of purge gas into the interior of the EMI-box 220. Since the EMI-box already defines a sealed, contained volume due in part to the presence of the second seals, the purge volume can be created by introducing a flow of purge gas at a purge input 222 and extracting the flow at a purge output 224. A gas source 226 can be used to provide the purge gas through the purge input 222. The gas source can be the same source used for other components of the laser system. The gas source 226 can be used to provide a flow at about atmospheric pressure, or at a slight overpressure, in order to carry any impurities out of the intermediate volume. Providing a gas pressure inside the intermediate volume that is slightly above atmospheric pressure can prevent impurities from flowing into the intermediate volume through the secondary seals 214, 216. The extracted flow can be filtered in order to remove any impurities, then introduced back into the EMI-box through the purge input 222. An advantage to using an EMI-box as the intermediate gas volume is that the EMI-box already covers the joint(s) between the ceramic channel component and the stainless steel bellow (not shown) as well as the joint with the baffle box 314 (shown for example in FIG. 3). These joints may not use seals per se, but might use other approaches such as welding to prevent leakage.

In one embodiment, the EMI-box 220 can be purged with a flow of nitrogen gas during operation. Using nitrogen gas can provide the proper hold-off voltage and prevent the risk of corona problems, as nitrogen can have electrical properties that are preferable to those of ambient air. Further, the permeation of nitrogen can be very small compared to the permeations of water and oxygen, such that less nitrogen would permeate into the chamber from the intermediate volume than would other impurities such as water and oxygen. Nitrogen also is considered to be compatible with the laser gas in many existing systems, such that any permeation by some amount of nitrogen gas has a negligible effect on operation. The flow of nitrogen gas can be at any appropriate rate, such as approximately 1-2 liters/minute. As a consequence, any corona resistors that might be adversely affected by the nitrogen gas may need to be removed from the EMI-box, and be placed into another appropriate location such as the solid state pulser. An advantage, however, is that the heat load of the corona resistors, which can be on the order of about 500 W, will not end up in the gas exhaust.

Another embodiment is shown in FIG. 3. In this arrangement, each secondary seal 302 is a vertically-oriented ring that forms a seal with a metal plate 304 or panel that forms a wall of the EMI-box 306. The secondary seal 302 fits into a groove 308 that is formed in the side of the pulser module 310 and the side of the EMI-box 306. The secondary o-ring 302 can be any appropriate o-ring, such as an o-ring made of a fluoro-elastomer such as Viton. An array of screws 312 can be used to attach the plate 304 to the pulser module and EMI-box, whereby the secondary ring 302 will be compressed to form the secondary seal. The first seals can still be positioned as shown in FIG. 2, and are not shown in this Figure. The first seals can be any appropriate rings or materials as discussed elsewhere herein. The EMI-box again can have a controlled intermediate gas volume introduced therein, between the first seals and each second seal 302 (the other second seal is opposite the second seal shown, but cannot be seen in the Figure). Other secondary seals can be used, such as a seal between the baffle box 314, which couples light out of the chamber, and the EMI-box. A purge gas input and purge gas output (not shown) can be used to introduce a flow of purge gas into the intermediate gas volume. This can be a flow of nitrogen, as discussed above, or a flow of a gas such as argon, which allows for the transport from the laser discharge unit via the EMI-box volume. The purge gas can be used during operation and, depending upon the amount of leakage and/or permeation, can be used during storage or non-operation in order to prevent contamination of the laser gas. The pressure inside the EMI-box can be maintained at a pressure such as 5-10 mbar above atmospheric pressure in order to resist the flow of impurities through the secondary seals into the intermediate gas volume.

While a fluro-elastomer ring might be appropriate for the secondary seals shown in FIGS. 1-3, other seals in a laser system might benefit from other sealing materials and/or technologies. For instance, special fluoro-elastomers without filler, such as Optic Armor fluoro-elastomers discussed above, can be used where the amount of outgassing and photo-chemically induced outgassing is important, such as between the baffle box and the reservoir chamber. Metal seals can be used between the bellow and the baffle box and/or between the baffle box and the window adapter. Various components, such as the pressure transducer, temperature sensor, and cooling coils, can be welded into place such that a seal is not necessary. There is a wide variety of combinations of seals that can depend upon the laser system and/or application, which will not be discussed in detail herein but would be obvious to one of ordinary skill in the art in light of the discussion herein. Proper selection of sealing technologies in one system can reduce the permeation rate down to 5%, and the o-ring area relevant to outgassing can be reduced by approximately 50%. An example of a selection of seals for a laser system can be found in U.S. Provisional Patent Application No. 60/512,165, entitled “RESERVOIR CHAMBER SEALING,” filed Oct. 17, 2004, which is incorporated herein by reference above.

In order to further improve performance, it can be desirable to choose a proper combination of materials for the components of the laser system. For example, one embodiment having a reservoir chamber with a ceramic channel uses a reservoir chamber made of standard or nickel-coated aluminum. The motor flange, cooling flange, cathode plate, and baffle box can each be electro-polished or nickel-coated stainless steel. The gas circulation fan can be standard aluminum, while the cooling coils can be nickel-coated copper. A complete reservoir chamber in accordance with one embodiment can be sealed with GARLOCK seals, wherein the tube and the cathode plate can be made of stainless steel to minimize thermally induced movement. The stainless steel surface of the tube can be electro-polished instead of being nickel coated.

Several seals in an existing system can be replaced through either welding or metal seals. However, the main seals of cathode plate and ceramic channel can remain of the o-ring type. Based on the present results, the optics mount may not be able to take the stress which is required for a reliable metal seal. The seal of the window mount to the tube window adapter can be an o-ring as well, in order to allow for easy field maintenance on the windows. The window can use a metal sealing in systems where this change will greatly improve the window lifetime.

Overall System

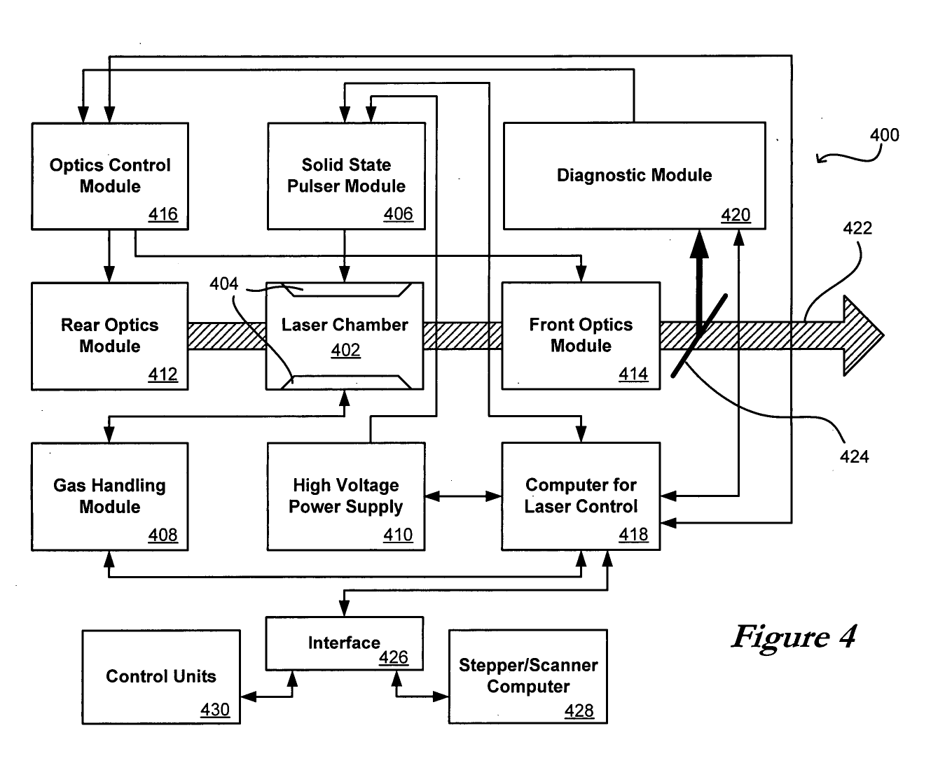

FIG. 4 schematically illustrates an exemplary excimer or molecular fluorine laser system 400 that can be used in accordance with various embodiments of the present invention. The gas discharge laser system can be a deep ultraviolet (DUV) or vacuum ultraviolet (VUV) laser system, such as an excimer laser system, e.g., ArF, XeCl or KrF, or a molecular fluorine (F₂) laser system for use with a DUV or VUV lithography system. Alternative configurations for laser systems, for use in such other industrial applications as TFT annealing, photoablation and/or micromachining, e.g., include configurations understood by those skilled in the art as being similar to, and/or modified from, the system shown in FIG. 4 to meet the requirements of that application.

The laser system 400 contains a discharge chamber 402 including a discharge channel having a plurality of electrodes 404, such as a pair of main discharge electrodes and one or more ionization electrodes or elements which can be connected with a solid-state pulser module 406, or with separate modules or circuitry as described elsewhere herein. The discharge chamber also includes a reservoir chamber, which can include a heat exchanger and fan for circulating a gas mixture within the chamber or tube. A gas handling module 408 can have a valve connection to the laser chamber 402, such that halogen, rare and buffer gases, and gas additives, can be injected or filled into the laser chamber, such as in premixed forms for ArF, XeCl and KrF excimer lasers, as well as halogen, buffer gases, and any gas additive for an F₂ laser. The gas handling module 408 can be preferred when the laser system is used for microlithography applications, wherein very high energy stability is desired. A gas handling module can be optional for a laser system such as a high power XeCl laser. A solid-state pulser module 406 can be used that is powered by a high voltage power supply 410. Alternatively, a thyratron pulser module can be used. The discharge chamber 402 can be surrounded by optics modules 412, 414, forming a resonator. The optics modules 412, 414 can include a highly reflective resonator reflector in the rear optics module 412, and a partially reflecting output coupling mirror in the front optics module 414. This optics configuration can be preferred for a high power XeCl laser. The optics modules 412, 414 can be controlled by an optics control module 416, or can be directly controlled by a computer or processor 418, particularly when line-narrowing optics are included in one or both of the optics modules. Line-narrowing optics can be preferred for systems such as KrF, ArF or F₂ laser systems used for optical lithography.

The processor 418 for laser control can receive various inputs and control various operating parameters of the system. A diagnostic module 420 can receive and measure one or more parameters of a split off portion of the main beam 422 via optics for deflecting a small portion of the beam toward the module 420. These parameters can include pulse energy, average energy and/or power, and wavelength. The optics for deflecting a small portion of the beam can include a beam splitter module 424. The beam 422 can be laser output to an imaging system (not shown) and ultimately to a workpiece (also not shown), such as for lithographic applications, and can be output directly to an application process. Laser control computer 418 can communicate through an interface 426 with a stepper/scanner computer, other control units 428, 430, and/or other, external systems.

The processor or control computer 416 can receive and process parameter values, such as may include the pulse shape, energy, ASE, energy stability, energy overshoot (for burst mode operation), wavelength, spectral purity, and/or bandwidth, as well as other input or output parameters of the laser system and/or output beam. The processor can receive signals corresponding to the wavefront compensation, such as values of the bandwidth, and can control wavefront compensation, performed by a wavefront compensation optic in a feedback loop, by sending signals to adjust the pressure(s) and/or curvature(s) of surfaces associated with the wavefront compensation optic. The processor 416 also can control the line narrowing module to tune the wavelength, bandwidth, and/or spectral purity, and can control the power supply 408 and pulser module 404 to control the moving average pulse power or energy, such that the energy dose at points on a workpiece is stabilized around a desired value. The laser control computer 416 also can control the gas handling module 406, which can include gas supply valves connected to various gas sources.

The discharge chamber 402 can contain a laser gas mixture, and can include one or more ionization electrodes in addition to the pair of main discharge electrodes. The main electrodes can be similar to those described at U.S. Pat. No. 6,466,599 BI (incorporated herein by reference above) for photolithographic applications, which can be configured for a XeCl laser when a narrow discharge width is not preferred.

The solid-state or thyratron pulser module 406 and high voltage power supply 410 can supply electrical energy in compressed electrical pulses to the ionization and/or main electrodes within the discharge chamber 402, in order to energize the gas mixture. The rear optics module 412 can include line-narrowing optics for a line narrowed excimer or molecular fluorine laser as described above, which can be replaced by a high reflectivity mirror or the like in a laser system wherein either line-narrowing is not desired (XeCl laser for TFT annealling, e.g.), or if line narrowing is performed at the front optics module 414, or a spectral filter external to the resonator is used, or if the line-narrowing optics are disposed in front of the HR mirror, for narrowing the bandwidth of the output beam.

The discharge chamber 402 can be sealed by windows transparent to the wavelengths of the emitted laser radiation 422. The windows can be Brewster windows, or can be aligned at an angle, such as on the order of about 5°, to the optical path of the resonating beam. One of the windows can also serve to output couple the beam.

After a portion of the output beam 422 passes the outcoupler of the front optics module 414, that output portion can impinge upon a beam splitter module 424 including optics for deflecting a portion of the beam to the diagnostic module 420, or otherwise allowing a small portion of the outcoupled beam to reach the diagnostic module 420, while a main beam portion is allowed to continue as the output beam 420 of the laser system. The optics can include a beamsplitter or otherwise partially reflecting surface optic, as well as a mirror or beam splitter as a second reflecting optic. More than one beam splitter and/or HR mirror(s), and/or dichroic mirror(s) can be used to direct portions of the beam to components of the diagnostic module 420. A holographic beam sampler, transmission grating, partially transmissive reflection diffraction grating, grism, prism or other refractive, dispersive and/or transmissive optic or optics can also be used to separate a small beam portion from the main beam 422 for detection at the diagnostic module 420, while allowing most of the main beam 422 to reach an application process directly, via an imaging system or otherwise.

The output beam 422 can be transmitted at the beam splitter module, while a reflected beam portion is directed at the diagnostic module 420. Alternatively, the main beam 422 can be reflected while a small portion is transmitted to a diagnostic module 420. The portion of the outcoupled beam which continues past the beam splitter module can be the output beam 422 of the laser, which can propagate toward an industrial or experimental application such as an imaging system and workpiece for photolithographic applications.

For a system such as a molecular fluorine laser system or ArF laser system, an enclosure (not shown) can be used to seal the beam path of the beam 422 in order to keep the beam path free of photoabsorbing species. Smaller enclosures can seal the beam path between the chamber 402 and the optics modules 412 and 414, as well as between the beam splitter 424 and the diagnostic module 420.

The diagnostic module 420 can include at least one energy detector to measure the total energy of the beam portion that corresponds directly to the energy of the output beam 422. An optical configuration such as an optical attenuator, plate, coating, or other optic can be formed on or near the detector or beam splitter module 424, in order to control the intensity, spectral distribution, and/or other parameters of the radiation impinging upon the detector.

A wavelength and/or bandwidth detection component can be used with the diagnostic module 420, the component including for example such as a monitor etalon or grating spectrometer. Other components of the diagnostic module can include a pulse shape detector or ASE detector, such as for gas control and/or output beam energy stabilization, or to monitor the amount of amplified spontaneous emission (ASE) within the beam, in order to ensure that the ASE remains below a predetermined level. There can also be a beam alignment monitor and/or beam profile monitor.

The processor or control computer 418 can receive and process values for the pulse shape, energy, ASE, energy stability, energy overshoot for burst mode operation, wavelength, and spectral purity and/or bandwidth, as well as other input or output parameters of the laser system and output beam. The processor 418 also can control the line narrowing module to tune the wavelength and/or bandwidth or spectral purity, and can control the power supply 410 and pulser module 406 to control the moving average pulse power or energy, such that the energy dose at points on the workpiece can be stabilized around a desired value. In addition, the computer 418 can control the gas handling module 408, which can include gas supply valves connected to various gas sources. Further functions of the processor 418 can include providing overshoot control, stabilizing the energy, and/or monitoring energy input to the discharge.

The processor 418 can communicate with the solid-state or thyratron pulser module 406 and HV power supply 410, separately or in combination, the gas handling module 408, the optics modules 412 and/or 414, the diagnostic module 420, and an interface 426. The processor 418 also can control an auxiliary volume, which can be connected to a vacuum pump (not shown) for releasing gases from the reservoir chamber 402 and for reducing a total pressure in the tube. The pressure in the tube can also be controlled by controlling the gas flow through the ports to and from the additional volume.

The laser gas mixture initially can be filled into the discharge chamber 402 in a process referred to herein as a “new fill”. In such procedure, the reservoir chamber can be evacuated of laser gases and contaminants, and re-filled with an ideal gas composition of fresh gas. The gas composition for a very stable excimer or molecular fluorine laser can use helium or neon, or a mixture of helium and neon, as buffer gas(es), depending on the laser being used. The concentration of the fluorine in the gas mixture can range from 0.003% to 1.00%, in some embodiments is preferably around 0.1%. An additional gas additive, such as a rare gas or otherwise, can be added for increased energy stability, overshoot control, and/or as an attenuator. Specifically for a F₂-laser, an addition of xenon, krypton, and/or argon can be used. The concentration of xenon or argon in the mixture can range from about 0.0001% to about 0.1%. For an ArF-laser, an addition of xenon or krypton can be used, also having a concentration between about 0.0001% to about 0.1%. For the KrF laser, an addition of xenon or argon may be used also over the same concentration.

Halogen and rare gas injections, including micro-halogen injections of about 1-3 milliliters of halogen gas, mixed with about 20-60 milliliters of buffer gas, or a mixture of the halogen gas, the buffer gas, and a active rare gas, per injection for a total gas volume in the reservoir chamber on the order of about 100 liters, for example. Total pressure adjustments and gas replacement procedures can be performed using the gas handling module, which can include a vacuum pump, a valve network, and one or more gas compartments. The gas handling module can receive gas via gas lines connected to gas containers, tanks, canisters, and/or bottles. A xenon gas supply can be included either internal or external to the laser system.

Total pressure adjustments in the form of releases of gases or reduction of the total pressure within the reservoir chamber also can be performed. Total pressure adjustments can be followed by gas composition adjustments if necessary. Total pressure adjustments can also be performed after gas replenishment actions, and can be performed in combination with smaller adjustments of the driving voltage to the discharge than would be made if no pressure adjustments were performed in combination.

Gas replacement procedures can be performed, and can be referred to as partial, mini-, or macro-gas replacement operations, or partial new fill operations, depending on the amount of gas replaced. The amount of gas replaced can be anywhere from a few milliliters up to about 50 liters or more, but can be less than a new fill. As an example, the gas handling unit connected to the reservoir chamber, either directly or through an additional valve assembly, such as may include a small compartment for regulating the amount of gas injected, can include a gas line for injecting a premix A including 1% F₂:99% Ne, and another gas line for injecting a premix B including 1% Kr:99% Ne, for a KrF laser. For an ArF laser, premix B can have Ar instead of Kr, and for a F₂ laser premix B may not be used. Thus, by injecting premix A and premix B into the tube via the valve assembly, the fluorine and krypton concentrations (for the KrF laser, e.g.) in the reservoir chamber, respectively, can be replenished. A certain amount of gas can be released that corresponds to the amount that was injected. Additional gas lines and/or valves can be used to inject additional gas mixtures. New fills, partial and mini gas replacements, and gas injection procedures, such as enhanced and ordinary micro-halogen injections on the order of between 1 milliliter or less and 3-10 milliliters, and any and all other gas replenishment actions, can be initiated and controlled by the processor, which can control valve assemblies of the gas handling unit and the reservoir chamber based on various input information in a feedback loop.

Line-narrowing features in accordance with various embodiments of a laser system can be used along with the wavefront compensating optic. For an F₂ laser, the optics can be used for selecting the primary line λ from multiple lines around 157 nm. The optics can be used to provide additional line narrowing and/or to perform line-selection. The resonator can include optics for line-selection, as well as optics for line-narrowing of the selected line. Line-narrowing can be provided by controlling (i.e., reducing) the total pressure.

Exemplary line-narrowing optics contained in the rear optics module can include a beam expander, an optional interferometric device such as an etalon and a diffraction grating, which can produce a relatively high degree of dispersion, for a narrow band laser such as is used with a refractive or catadioptric optical lithography imaging system. As mentioned above, the front optics module can include line-narrowing optics as well.

Instead of having a retro-reflective grating in the rear optics module, the grating can be replaced with a highly reflective mirror. A lower degree of dispersion can be produced by a dispersive prism, or a beam expander and an interferometric device such as an etalon. A device having non-planar opposed plates can be used for line-selection and narrowing, or alternatively no line-narrowing or line-selection may be performed in the rear optics module. In the case of an all-reflective imaging system, the laser can be configured for semi-narrow band operation, such as may have an output beam linewidth in excess of 0.5 pm, depending on the characteristic broadband bandwidth of the laser. Additional line-narrowing of the selected line can then be avoided, instead being provided by optics or by a reduction in the total pressure in the reservoir chamber.

For a semi-narrow band laser such as is used with an all-reflective imaging system, the grating can be replaced with a highly reflective mirror, and a lower degree of dispersion can be produced by a dispersive prism. A semi-narrow band laser would typically have an output beam linewidth in excess of 1 pm, and can be as high as 100 pm in some laser systems, depending on the characteristic broadband bandwidth of the laser.

The beam expander of the above exemplary line-narrowing optics of the rear optics module can include one or more prisms. The beam expander can include other beam expanding optics, such as a lens assembly or a converging/diverging lens pair. The grating or a highly reflective mirror can be rotatable so that the wavelengths reflected into the acceptance angle of the resonator can be selected or tuned. Alternatively, the grating, or other optic or optics, or the entire line-narrowing module, can be pressure tuned. The grating can be used both for dispersing the beam for achieving narrow bandwidths, as well as for retro-reflecting the beam back toward the reservoir chamber. Alternatively, a highly reflective mirror can be positioned after the grating, which can receive a reflection from the grating and reflect the beam back toward the grating in a Littman configuration. The grating can also be a transmission grating. One or more dispersive prisms can also be used, and more than one etalon can be used. Depending on the type and extent of line-narrowing and/or selection and tuning that is desired, and the particular laser that the line-narrowing optics are to be installed into, there are many alternative optical configurations that can be used.

A front optics module can include an outcoupler for outcoupling the beam, such as a partially reflective resonator reflector. The beam can be otherwise outcoupled by an intra-resonator beam splitter or partially reflecting surface of another optical element, and the optics module could in this case include a highly reflective mirror. The optics control module can control the front and rear optics modules, such as by receiving and interpreting signals from the processor and initiating realignment or reconfiguration procedures.

The material used for any dispersive prisms, beam expander prisms, etalons or other interferometric devices, laser windows, and/or the outcoupler can be a material that is highly transparent at excimer or molecular fluorine laser wavelengths, such as 248 nm for the KrF laser, 193 nm for the ArF laser and 157 nm for the F₂ laser. The material can be capable of withstanding long-term exposure to ultraviolet light with minimal degradation effects. Examples of such materials can include CaF₂, MgF₂, BaF2, LiF, and SrF₂. In some cases fluorine-doped quartz can be used, while fused silica can be used for the KrF laser. Many optical surfaces, particularly those of the prisms, can have an anti-reflective coating, such as on one or more optical surfaces of an optic, in order to minimize reflection losses and prolong optic lifetime.

Various embodiments relate particularly to excimer and molecular fluorine laser systems configured for adjustment of an average pulse energy of an output beam, using gas handling procedures of the gas mixture in the reservoir chamber. The halogen and the rare gas concentrations can be maintained constant during laser operation by gas replenishment actions for replenishing the amount of halogen, rare gas, and buffer gas in the reservoir chamber for KrF and ArF excimer lasers, and halogen and buffer gas for molecular fluorine lasers, such that these gases can be maintained in a same predetermined ratio as are in the reservoir chamber following a new fill procedure. In addition, gas injection actions such as μHIs can be advantageously modified into micro gas replacement procedures, such that the increase in energy of the output laser beam can be compensated by reducing the total pressure. In contrast, or alternatively, conventional laser systems can reduce the input driving voltage so that the energy of the output beam is at the predetermined desired energy. In this way, the driving voltage is maintained within a small range around HVₒₚₜ, while the gas procedure operates to replenish the gases and maintain the average pulse energy or energy dose, such as by controlling an output rate of change of the gas mixture or a rate of gas flow through the reservoir chamber.

Further stabilization by increasing the average pulse energy during laser operation can be advantageously performed by increasing the total pressure of gas mixture in the reservoir chamber up to Pₘₐₓ. Advantageously, the gas procedures set forth herein permit the laser system to operate within a very small range around HVₒₚₜ, while still achieving average pulse energy control and gas' replenishment, and increasing the gas mixture lifetime or time between new fills.

A laser system having a discharge chamber with a same gas mixture, total gas pressure, constant distance between the electrodes and constant rise time of the charge on laser peaking capacitors of the pulser module, can also have a constant breakdown voltage. The operation of the laser can have an optimal driving voltage HVₒₚₜ, at which the generation of a laser beam has a maximum efficiency and discharge stability.

Variations on embodiments described herein can be substantially as effective. For instance, the energy of the laser beam can be continuously maintained within a tolerance range around the desired energy by adjusting the input driving voltage. The input driving voltage can then be monitored. When the input driving voltage is above or below the optimal driving voltage HVₒₚₜ by a predetermined or calculated amount, a total pressure addition or release, respectively, can be performed to adjust the input driving voltage a desired amount, such as closer to HVₒₚₜ, or otherwise within a tolerance range of the input driving voltage. The total pressure addition or release can be of a predetermined amount of a calculated amount, such as described above. In this case, the desired change in input driving voltage can be determined to correspond to a change in energy, which would then be compensated by the calculated or predetermined amount of gas addition or release, such that similar calculation formulas may be used as described herein.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

1. An excimer or molecular fluorine laser system, comprising:
a discharge channel containing a pair of electrodes for energizing a laser gas to generate an optical pulse;
a reservoir chamber forming a primary closed volume with the discharge channel and containing a circulation mechanism for circulating the laser gas between the pair of electrodes;
a primary seal positioned between the discharge channel and the reservoir chamber in order to inhibit a flow of gas into the primary closed volume; and
a secondary seal positioned between the first seal and a surrounding environment, the secondary seal forming an intermediate closed volume in the laser system between the primary closed volume and the surrounding environment, wherein the secondary seal inhibits a flow of gas into the intermediate closed volume from the surrounding environment.

2. A laser system according to claim 1, further comprising:
a gas source having an input into the intermediate closed volume, the gas source providing a flow of gas into the intermediate closed volume

3. A system according to claim 2, wherein:
the gas source provides a flow of gas that is capable of maintaining an elevated pressure inside the intermediate closed volume to inhibit the flow of gas from the surrounding environment into the intermediate closed volume.

4. A system according to claim 3, wherein:
the elevated pressure is in the range of about 5-10 mbar above a pressure of the surrounding environment.

5. A laser system according to claim 2, further comprising:
an output from the intermediate gas allowing the flow of gas to exit the intermediate closed volume, thereby removing impurities from the intermediate closed volume.

6. A system according to claim 1, further comprising:
an EMI box surrounding at least a portion of the discharge channel for shielding radiation generated by the discharge channel, wherein the intermediate closed volume formed by the secondary seal is an interior volume of the EMI box.

7. A system according to claim 1, wherein:
at least one of the primary and secondary seals is a fluoro-elastomer seal.

8. A system according to claim 1, wherein:
at least one of the primary and secondary seals is a perfluoro-elastomer seal.

9. A system according to claim 1, wherein:
at least one of the primary and secondary seals is an o-ring.

10. A system according to claim 1, wherein:
the impurities are selected from the group consisting of helium, oxygen, and water.

11. A system according to claim 1, wherein:
the reservoir chamber is an aluminum reservoir chamber.

12. A system according to claim 1, wherein:
the discharge channel includes a ceramic channel member in contact with the reservoir chamber, wherein the primary seal is positioned between the reservoir chamber and the ceramic channel member.

13. A system according to claim 1, wherein:
the intermediate closed volume is maintained at a lower pressure than the surrounding environment during operation.

14. A system according to claim 5, wherein:
the gas source further includes a filter for removing impurities from the gas having passed through the intermediate closed volume, whereby the filtered gas can be recirculated through the intermediate closed volume.

15. A system according to claim 1, wherein:
the flow of gas is a flow of nitrogen gas.

16. A system according to claim 1, wherein:
the flow of gas is a flow of argon gas.

17. A system according to claim 1, wherein:
the gas source provide the flow of gas at a flow rate in the range of about 1-2 liters/minute.

18. A system according to claim 1, further comprising:
a cathode plate in contact with the discharge channel and forming a portion of the primary closed volume, wherein an additional primary seal is positioned between the discharge channel and the cathode plate in order to substantially seal the primary closed volume from the surrounding environment.

19. A system according to claim 1, further comprising:
at least one additional secondary seal positioned between the first seal and the surrounding environment for forming the intermediate closed volume.

20. An excimer or molecular fluorine laser system, comprising:
a discharge channel containing a pair of electrodes for energizing a laser gas to generate an optical pulse;
a reservoir chamber forming a primary closed volume with the discharge channel and containing a circulation mechanism for circulating the laser gas between the pair of electrodes;
a primary seal positioned between the discharge channel and the reservoir chamber in order to inhibit a flow of gas into the primary closed volume;
an EMI box surrounding at least a portion of the discharge channel for shielding radiation generated by the discharge channel; and
a secondary seal forming an intermediate closed volume in the EMI box between the primary closed volume and the surrounding environment, wherein the secondary seal inhibits a flow of gas into the intermediate closed volume from the surrounding environment.

21. A method for minimizing the presence of impurities in the laser gas of an excimer or molecular fluorine laser system, comprising the steps of:
sealing a primary closed volume contained within a discharge channel and reservoir chamber of the laser system using at least one primary seal, the primary closed volume containing the laser gas;
forming an intermediate closed volume between the primary closed volume and a surrounding environment using at least one secondary seal; and
directing a flow of gas into the intermediate closed volume in order to create an internal pressure in the intermediate gas volume at above an exterior pressure of the surrounding environment, in order to resist flow of the impurities through the at least one secondary seal

22. A method according to claim 21, further comprising:
allowing the flow of gas to flow from the intermediate closed volume in order to remove any impurities that diffuse through the at least one secondary seal before those impurities can permeate the at least one primary seal.

23. A method according to claim 21, further comprising:
the internal pressure is maintained in the range of about 5-10 mbar above the exterior atmosphere.

24. A method according to claim 21, wherein:
forming the intermediate closed volume involves using the at least one secondary seal to seal an EMI box surrounding at least a portion of the discharge channel for shielding radiation generated by the discharge channel, wherein the intermediate closed volume is an interior volume of the EMI box.

25. A method according to claim 21, wherein:
forming the intermediate closed involves using at least one secondary seal formed of a fluoro-elastomer material.

26. A method according to claim 21, wherein:
forming the intermediate closed involves using at least one secondary seal formed of a perfluoro-elastomer material.

27. A method according to claim 21, wherein:
at least one of the primary and secondary seals is an o-ring.

28. A method according to claim 21, wherein:
the impurities are selected from the group consisting of helium, oxygen, and water.

29. A method according to claim 21, wherein:
the reservoir chamber is an aluminum reservoir chamber.

30. A method according to claim 21, wherein:
the discharge channel includes a ceramic channel member in contact with the reservoir chamber, wherein at least one primary seal is positioned between the reservoir chamber and the ceramic channel member.

31. A method according to claim 21, further comprising:
filtering impurities from the gas having passed through the intermediate closed volume, whereby the filtered gas can be recirculated through the intermediate closed volume.

32. A method according to claim 21, wherein:
the flow of gas is a flow of nitrogen gas.

33. A method according to claim 21, wherein:
the flow of gas is a flow of argon gas.

34. A method according to claim 21, wherein:
directing a flow of gas through the intermediate closed volume involves directing the flow of gas at a flow rate in the range of about 1-2 liters/minute.
